(19) United States
(12) Patent Application Publication
(10) Pub. No.: US 2008/0204183 A1
(43) Pub. Date: Aug. 28, 2008

(54) 3D-COIL FOR SAVING AREA USED BY INDUCTANCES

(75) Inventor: Andreas Ishak Loza, Dusseldorf (DE)

Correspondence Address: SCHWEGMAN, LUNDBERG & WOESSNER / INFINEON, P.O. BOX 2938, MINNEAPOLIS, MN, 55402, US

(73) Assignee: INFINEON TECHNOLOGIES AG, MUNICH (DE)

(21) Appl. No.: 11/678,486

(22) Filed: Feb. 23, 2007

(51) Int. Cl. H01F 5/00

(52) U.S. Cl. 336/200

(57) ABSTRACT

Some embodiments discussed relate to an apparatus, including a planar coil that is disposed in a metallization above and perpendicular to a substrate. Some embodiments include a plurality of planar coils that are disposed in the metallization above and perpendicular to the substrate, and that may be electrically connected, or only inductively coupled. A process includes the formation of the planar coil. A method includes using the planar coil as an inductor that is disposed perpendicular to the substrate. A method includes a plurality of spaced apart planar coils that are used as a transformer apparatus.

### TECHNICAL FIELD

Embodiments described herein relate generally to inductors and more particularly, to use of inductors with microelectronic devices.

### BACKGROUND

Inductors are used with microelectronic devices as passive elements for configuration of the devices to achieve certain functionalities. Miniaturization is the process of crowding more devices, both passive and active, onto the same or an even smaller footprint of a microelectronic device. The crowding of more devices into even smaller areas, poses significant challenges.

### BRIEF DESCRIPTION OF THE DRAWINGS

FIG. 1 is an exploded perspective in cross section of an inductor coil, according to some embodiments of the invention.

FIG. 2 is a perspective view of a form factor for a planar inductor coil according to an embodiment.

FIG. 3 is a perspective view of a form factor for a planar inductor coil according to an embodiment.

FIG. 4 is a perspective view of a form factor for a planar inductor coil according to an embodiment.

FIG. 5 represents three perspective views of a planar first inductor coil and a planar subsequent inductor coil, according to some embodiments.

FIG. 6 represents a perspective view of a plurality of spaced-apart inductor coils, according to some embodiments.

FIG. 7 is a black-box perspective of two inductively coupled, spaced-apart inductor coils according to some embodiments.

FIG. 8 is a black-box perspective of two inductively coupled, spaced-apart inductor coils according to some embodiments.

FIG. 9 is a black-box perspective of two inductively coupled, spaced-apart inductor coils according to some embodiments.

FIG. 10 is a process-flow diagram according to some embodiments.

FIG. 11 is a method-flow diagram according to some embodiments.

### DETAILED DESCRIPTION

The following detailed description refers to the accompanying drawings that show, by way of illustration, specific details and embodiments in which embodiments may be practiced. Other embodiments may be utilized and structural, logical, and electrical changes may be made without departing from the scope of the disclosed embodiments. The various embodiments are not necessarily mutually exclusive, as some embodiments can be combined with one or more other embodiments to form new embodiments.

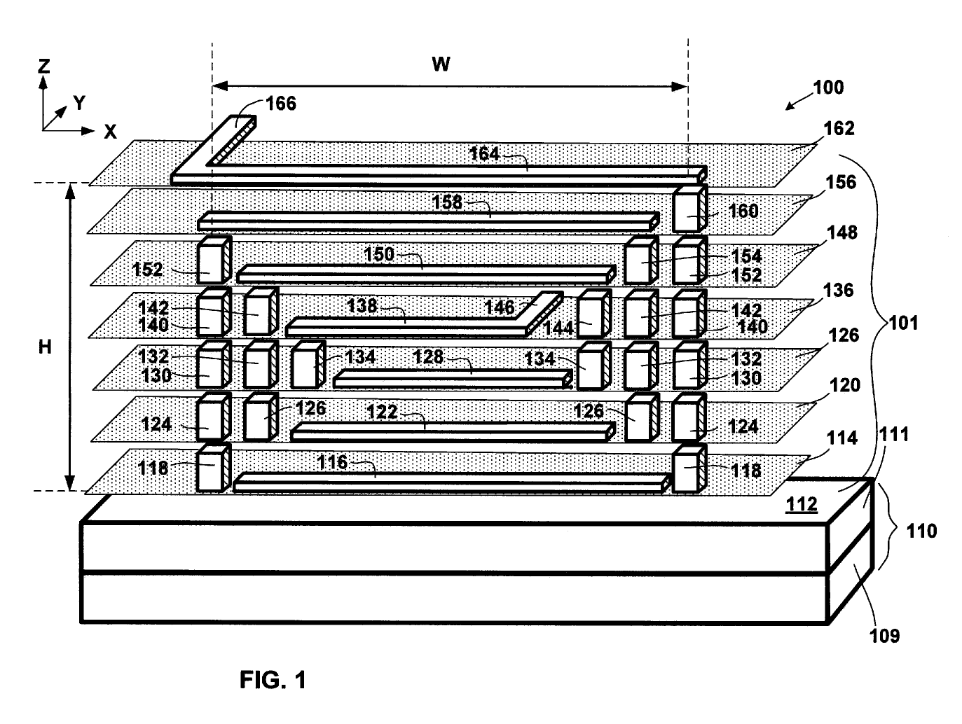

FIG. 1 is an exploded perspective 100 in cross section of a planar coil 101, according to some embodiments of the invention. In some embodiments, the planar coil 101 can be referred to as a planar inductor coil. A substrate 110 including a first surface 112 is depicted in cross sectional perspective. In an embodiment, the substrate 110 is a printed wiring board, and a wiring layer 111 is disposed above a structural layer 109. In an embodiment, the substrate 110 is a semiconductive device, and a device layer 111 is disposed above structural layer 109. In an embodiment, the substrate 110 is a semiconductive chip, and an active layer 111 (meaning a layer of semiconductive devices) is disposed above a structural layer 109. In this embodiment, the structural layer 109 can be semiconductive material without circuitry disposed therein.

The planar coil 101 is depicted disposed perpendicular to the first surface 112 such that the planar coil lies in an X-Z plane, and the first surface 112 lies in an X-Y plane. In an embodiment, the planar coil 101 is made with ordinary deviations from exact alignment as experienced sometimes in the chip-fabricating and chip-packaging arts. In any event, the planar coil 101 is perpendicular with respect to the first surface 112, within the deviations that are experienced the art. In the exploded perspective, the planar coil 101 is depicted as being a section of a metallization above the first surface 112. FIG. 1 depicts metal-one (M1) up through metal-seven (M7), but other metallizations that are greater or lesser than M7 can be used according to the various disclosed embodiments.

A passivation first layer 114 is disposed above the first surface 112. Where the substrate 110 is a microelectronic die, the passivation first layer 114 can be a material such as a polyimide dielectric or the like. Disposed upon the passivation first layer 114 is M1, which includes an M1 trace 116 and a plurality of M1 perimeter vias 118. In this disclosure, the term “via” can mean a filled contact. Above the level of M1, an M2 level includes a dielectric second layer 120, an M2 trace 122, a plurality of M2 perimeter vias 124, and a plurality of M2 intermediate vias 126. Above the level of M2, an M3 level includes a dielectric third layer 126, an M3 trace 128, a plurality of M3 perimeter vias 130, a plurality of M3 intermediate vias 132, and a plurality of M3 center vias 134. According to terminology, the center region of the planar coil 101 begins to be defined as including the M3 center vias 134.

Above the level of M3, an M4 level includes a dielectric fourth layer 136, an M4 trace 138, a plurality of M4 perimeter vias 140, a plurality of M4 intermediate vias 142, and an M4 center via 144. Further to the structure of M4, a coil center lead 146 is configured to exit the X-Z plane in which the planar coil 101 is arrayed. Above the level of M4, an M5 level includes a dielectric fifth layer 148, an M5 trace 150, a plurality of M5 perimeter vias 152, and an M5 intermediate via 154. According to terminology, the center region of the planar coil 101 is more completely defined by the coil center lead 146, the M4 trace 138, the M3 center vias 134, the M3 trace 128, the M4 center via 144, and the M5 trace 150. This recitation of structure completes one full turn within the planar coil 101.

Above the level of M5, an M6 level includes a dielectric sixth layer 156, an M6 trace 158, and an M6 perimeter via 160. Above the level of M6, an M7 level includes a dielectric seventh layer 162, an M7 trace 164. Further to the structure of M7, a coil perimeter lead 166 is configured to exit the plane X-Z in which the planar coil 101 is arrayed. According to terminology, the perimeter region of the planar coil 101 is defined by the coil perimeter lead 166, and proceeding clockwise, to include the M7 trace 164, and down the right side, the M6 perimeter via 160, the M5 perimeter via 152, the M4 perimeter via 140, the M3 perimeter via 130, the M2 perimeter via 124, the M1 perimeter via 118, the M1 trace 116, and up the left side, the M1 perimeter via 118, the M2 perimeter via 124, the M3 perimeter via 130, the M4 perimeter via 140, and the M5 perimeter via 152. This recitation of structure completes one full turn within the planar coil 101.

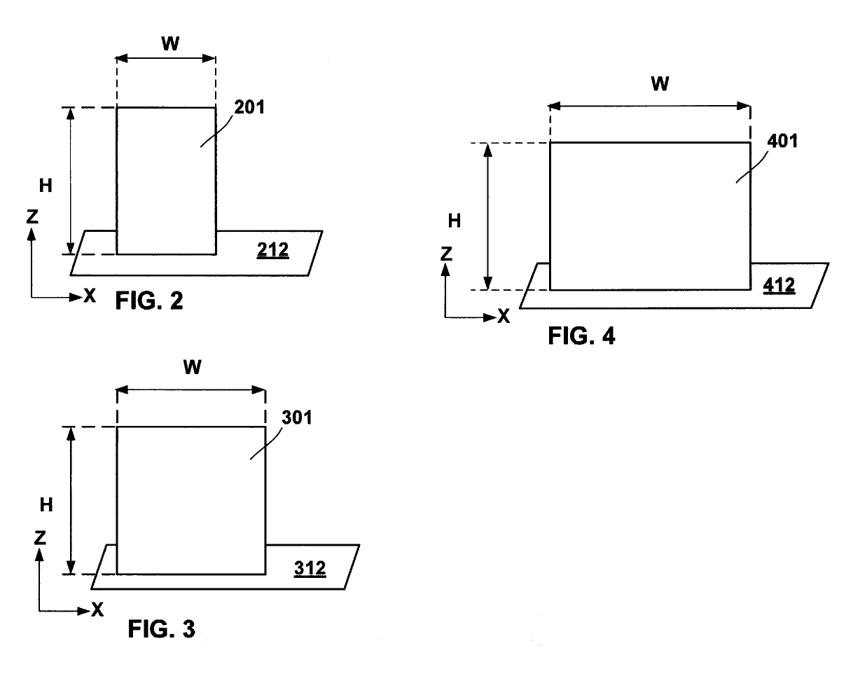

FIG. 2 is a perspective view of a form factor for a planar inductor coil 201 according to an embodiment. The planar inductor coil 201 has a height, H to width, W aspect ratio that is greater than 1. The planar inductor coil 201 is depicted perpendicular to a substrate first surface 212 that represents a substrate upon which the planar inductor coil 201 is mounted. The planar inductor coil 201, with an aspect ratio of greater than 1, will be able to exhibit a lower inductance, L, and a higher parasitic capacitance. In an embodiment, the aspect ratio of the planar inductor coil 301 is in a range from about 5:1 to about 1.1:1. In an embodiment, the aspect ratio of the planar inductor coil 301 is in a range from about 3:1 to about 2:1.

FIG. 3 is a perspective view of a form factor for a planar inductor coil 301 according to an embodiment. The planar inductor coil 301 is depicted perpendicular to a substrate first surface 312 upon which the planar inductor coil 201 is mounted. The planar inductor coil 301 has a height, H to width, W aspect ratio that is equal to 1. The planar inductor coil 301, with an aspect ratio of equal to 1, will be able to exhibit a medium inductance, L, and a medium parasitic capacitance.

FIG. 4 is a perspective view of a form factor for a planar inductor coil 401 according to an embodiment. The planar inductor coil 401 is depicted perpendicular to a substrate first surface 412 that represents a substrate upon which the planar inductor coil 201 is mounted. The planar inductor coil 401 has a height, H to width, W aspect ratio that is less than 1. The planar inductor coil 401, with an aspect ratio of less than 1, will be able to exhibit a higher inductance, L, and a lower parasitic capacitance. In an embodiment, the aspect ratio of the planar inductor coil 401 is in a range from about 0.1:1 to about 0.9:1. In other words, the form factor of the planar inductor coil 401 is in a range from about 10 times as wide, W as high, H. In an embodiment, the aspect ratio of the planar inductor coil 401 is in a range from about 0.25:1 to about 0.75:1. In an embodiment, the aspect ratio of the planar inductor coil 401 is in a range from about 0.4:1 to about 0.6:1.

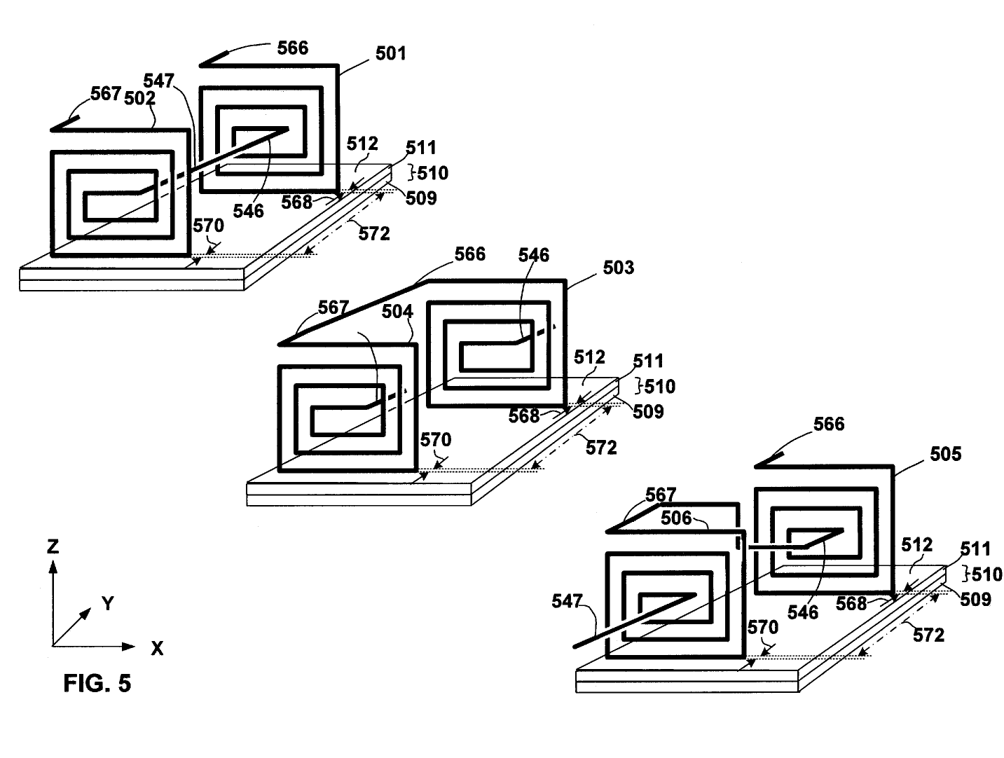

FIG. 5 represents three perspective views 500 of a planar first inductor coil and a planar subsequent inductor coil, according to some embodiments. A substrate 510 including a first surface 512 is provided. In an embodiment, the substrate 510 includes an active layer 511 and a structural layer 509. The planar inductor first coil 501 is configured perpendicular to the substrate first surface 512. The planar inductor first coil 501 is similar in configuration to the planar inductor coil 101 depicted in FIG. 1. Similarly, interlayer dielectric layers are also not represented in FIG. 5, but they can also be mapped from FIG. 1 for similarity. A coil center lead 546 is configured to exit the plane in which the planar inductor first coil 501 is arrayed. A coil perimeter lead 566 is configured to exit the plane in which the planar first coil 501 is arrayed.

FIG. 5 depicts a plurality of parallel, spaced-apart planar coils, in the planar first coil 501 and the planar subsequent coil 502. A coil center lead 547 is configured to exit the plane in which the planar subsequent inductor coil 502 is arrayed. A coil perimeter lead 567 is configured to exit the plane in which the planar subsequent coil 502 is arrayed. In an embodiment, the coil center lead and the coil center lead 547 are an integral unit.

In the illustrate embodiment, the respective coil center lead 546 and coil perimeter lead 566 make physical connection to the planar subsequent coil 502. Accordingly, the inductive effect that can be created, absent internal resistance of the structures, can be larger that of a single planar coil.

In an embodiment, conductance of a given planar coil, e.g. planar coil 501, can be improved by widening the trace feature F1, which is labeled as item 568. In an embodiment, the trace feature F2, which is labeled as item 570, can also be changed to lower resistance. In an embodiment, F1 can be a different size from F2. A third feature, F3, which is labeled as item 572 represents spacing between the planar first coil 501 and the planar subsequent coil 503. In an embodiment, F3 is substantially the same as F1, and F1 and F2 are substantially equal. In an embodiment, one coil width compared to the adjacent other coil width is in a range from about 1:1 to about 10:1.

In an example embodiment, a planar coil with footprint dimensions of 115 micrometer (μm) by 3.5 μm, is disposed upon a first surface of a substrate. This represents a footprint of about 402.5 μm². The planar coil has a length of about 115 μm with three complete turns in the total of the coil, similar to the planar coil 101 depicted in FIG. 1. In an example embodiment, a planar coil with footprint dimensions of 115 μm by 7 μm, upon a first surface of a substrate. This represents a footprint of about 402.5 μm². The planar coil has a length of about 115 μm with three complete turns in the total of the coil, similar to the planar coil 101 depicted in FIG. 1.

A planar inductor first coil 503 is configured perpendicular to the substrate first surface 512. A coil center lead 546 is configured to exit the plane in which the planar inductor first coil 503 is arrayed. A coil perimeter lead 566 is configured to exit the plane in which the planar first coil 503 is arrayed.

FIG. 5 depicts a plurality of parallel, spaced-apart planar coils, in the planar first coil 503 and a planar subsequent coil 504. A coil center lead 547 is configured to exit the plane in which the planar subsequent inductor coil 504 is arrayed. A coil perimeter lead 567 is configured to exit the plane in which the planar subsequent coil 502 is arrayed. In an embodiment, the coil perimeter lead 566 and the coil perimeter lead 567 are an integral unit.

In the illustrate embodiment, the coil perimeter lead 566 make physical connection to the planar subsequent coil 502. Accordingly, the inductive effect that can be created, absent internal resistance of the structures, can be larger that of a single planar coil.

In an embodiment, conductance of a given planar coil, e.g. planar coil 503, can be improved by widening the trace feature F1, which is labeled as item 568. In an embodiment, the trace feature F2, which is labeled as item 570, can also be changed to lower resistance. In an embodiment, F1 can be a different size from F2. A third feature, F3, which is labeled as item 572 represents spacing between the planar first coil 503 and the planar subsequent coil 504. In an embodiment, F3 is substantially the same as F1, and F1 and F2 are substantially equal. In an embodiment, one coil width compared to the adjacent other coil width is in a range from about 1:1 to about 10:1.

A planar inductor first coil 505 is configured perpendicular to the substrate first surface 512. A coil center lead 546 is configured to exit the plane in which the planar inductor first coil 505 is arrayed. A coil perimeter lead 566 is configured to exit the plane in which the planar first coil 505 is arrayed.

FIG. 5 depicts a plurality of parallel, spaced-apart planar coils, in the planar first coil 505 and a planar subsequent coil 506. A coil center lead 547 is configured to exit the plane in which the planar subsequent inductor coil 506 is arrayed. A coil perimeter lead 567 is configured to exit the plane in which the planar subsequent coil 502 is arrayed. In an embodiment, the coil center lead 546 and the coil perimeter lead 567 are in direct physical contact through a link 568.

In the illustrate embodiment, the coil perimeter lead 567 make physical connection to the planar first coil 505. Accordingly, the inductive effect that can be created, absent internal resistance of the structures, can be larger that of a single planar coil.

In an embodiment, conductance of a given planar coil, e.g. planar coil 505, can be improved by widening the trace feature F1, which is labeled as item 568. In an embodiment, the trace feature F2, which is labeled as item 570, can also be changed to lower resistance. In an embodiment, F1 can be a different size from F2. A third feature, F3, which is labeled as item 572 represents spacing between the planar first coil 505 and the planar subsequent coil 506. In an embodiment, F3 is substantially the same as F1, and F1 and F2 are substantially equal. In an embodiment, one coil width compared to the adjacent other coil width is in a range from about 1:1 to about 10:1.

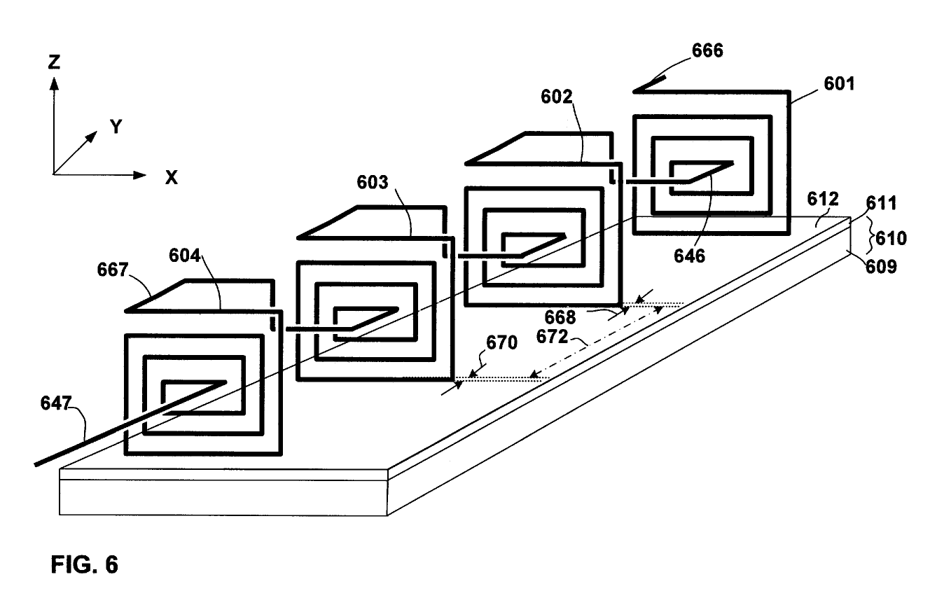

FIG. 6 represents a perspective view of a plurality of spaced-apart inductor coils, 601, 602, 603, and 604 according to some embodiments. A substrate 610 including a first surface 612 is provided. In an embodiment, the substrate 610 includes an active layer 611 and a structural layer 609.

The plurality of spaced-apart inductor coils includes a planar first coil 601, a planar second coil 602, a planar third coil 603, and a planar subsequent coil.

The planar inductor first coil 601 is configured perpendicular to the substrate first surface 612. Coupled to the planar inductor first coil 601 is a coil center lead 646. The coil center lead 646 is configured to exit the plane in which the planar inductor first coil 601 is arrayed. A coil perimeter lead 666 is configured to exit the plane in which the planar first coil 601 is arrayed.

FIG. 6 also depicts the planar subsequent coil 604. A coil center lead 647 is configured to exit the plane in which the planar subsequent inductor coil 604 is arrayed. A coil perimeter lead 667 is configured to exit the plane in which the planar subsequent coil 604 is arrayed. In an embodiment, the coil center lead 646 and the coil perimeter lead 667 are coupled through the planar second coil 602 and the planar third coil 603.

In an embodiment, conductance of a given planar coil, e.g. planar second coil 602, can be improved by widening the trace feature F1, which is labeled as item 668. In an embodiment, the trace feature F2, which is labeled as item 670, can also be changed to lower resistance. In an embodiment, F1 can be a different size from F2. A third feature, F3, which is labeled as item 672 represents spacing between the planar second coil 505 and the planar third coil 603. In an embodiment, F3 is substantially the same as F1, and F1 and F2 are substantially equal. In an embodiment, one coil width compared to the adjacent other coil width is in a range from about 1:1 to about 10:1.

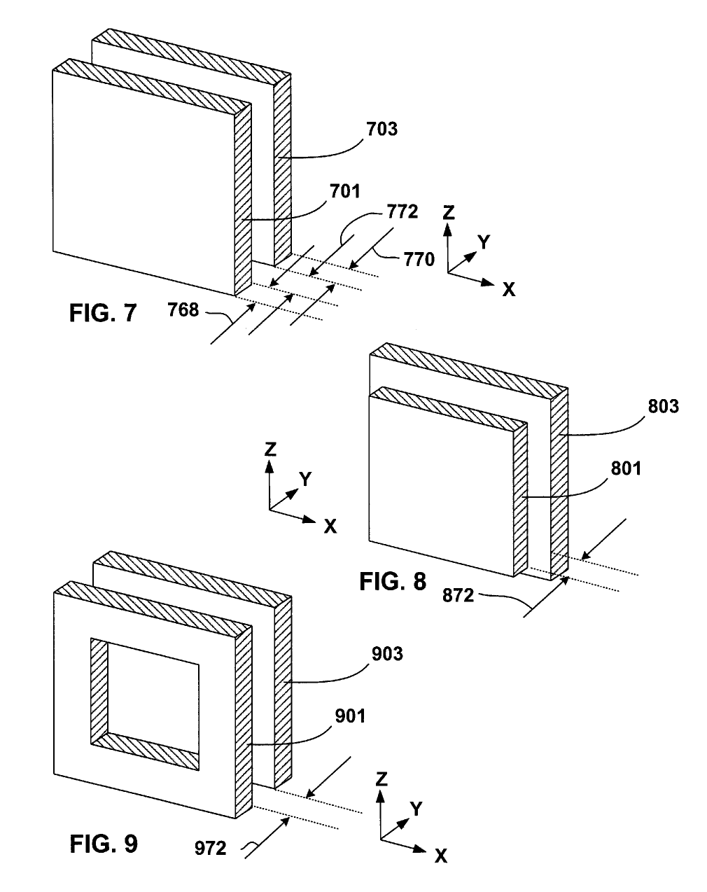

FIG. 7 is a black-box perspective of two inductively coupled, spaced-apart inductor coils 701 and 703 according to some embodiments. For simplicity also, center and perimeter leads are not illustrated. The two inductor coils 701 and 703 are depicted dispose in X-Z planes, and are presumed to be configured perpendicular to a first surface of a substrate upon which they are disposed.

The first coil 701 and the subsequent coil 703 are not electrically connected with a physical coupling like a bridge or a perimeter lead. Consequently, when one coil experiences an electrical current at a given potential therethrough, an inductive coupling is imposed upon the other coil, which results in a different electrical current and potential. In this configuration, a transformer apparatus is achieved. The effect of the transformer apparatus can depend upon the trace widths 768, 770, the intertrace spacing 772, and even the coil materials if they are dissimilar.

FIG. 8 is a black-box perspective of two inductively coupled, spaced-apart inductor coils 801 and 803 according to some embodiments. For simplicity also, center and perimeter leads are not illustrated. The two inductor coils 801 and 803 are depicted dispose in X-Z planes, and are presumed to be configured perpendicular to a first surface of a substrate upon which they are disposed.

The first coil 801 is depicted being smaller at the perimeter as the subsequent coil 803. In an embodiment, a fewer number of metallization layers are used to construct the first coil 801 compared to the subsequent coil 803.

The first coil 801 and the subsequent coil 803 are not electrically connected with a physical coupling like a bridge. Consequently, when one coil experiences an electrical current at a given potential therethrough, an inductive coupling is imposed upon the other coil, which results in a different electrical current and potential. In this configuration, a transformer apparatus is achieved. The effect of the transformer apparatus can depend upon the trace widths, the intertrace spacing 872, and even the coil materials if they are dissimilar.

FIG. 9 is a black-box perspective of two inductively coupled, spaced-apart inductor coils 901 and 903 according to some embodiments. For simplicity also, center and perimeter leads are not illustrated. The two inductor coils 901 and 903 are depicted dispose in X-Z planes, and are presumed to be configured perpendicular to a first surface of a substrate upon which they are disposed.

The first coil 901 is depicted with fewer interior coil turns as the subsequent coil 903. In an embodiment, a fewer number of metallization layers are used to construct the first coil 901 compared to the subsequent coil 903.

The first coil 901 and the subsequent coil 903 are not electrically connected with a physical coupling like a bridge. Consequently, when one coil experiences an electrical current at a given potential therethrough, an inductive coupling is imposed upon the other coil, which results in a different electrical current and potential. In this configuration, a transformer apparatus is achieved. The effect of the transformer apparatus can depend upon the trace widths, the intertrace spacing 972, and even the coil materials if they are dissimilar.

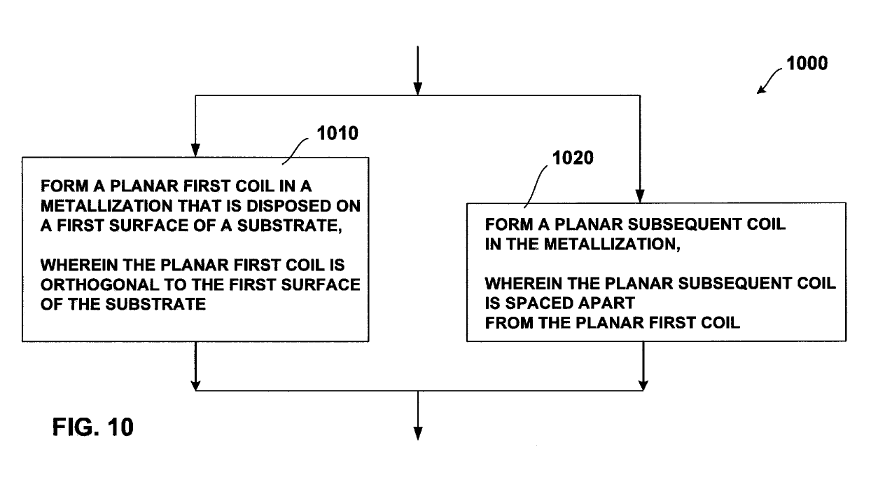

FIG. 10 is a process-flow diagram according to some embodiments.

At 1010, the process includes forming a planar first coil in a metallization that is disposed on a first surface of a substrate. The planar first coil is perpendicular to the first surface.

At 1020, the process includes forming a planar subsequent coil in the metallization. The planar subsequent coil is parallel and spaced apart from the planar first coil. The two process diagrams 1010 and 1020 are depicted as parallel in the process. Formation of the planar coils is carried out simultaneously with formation of the metallization.

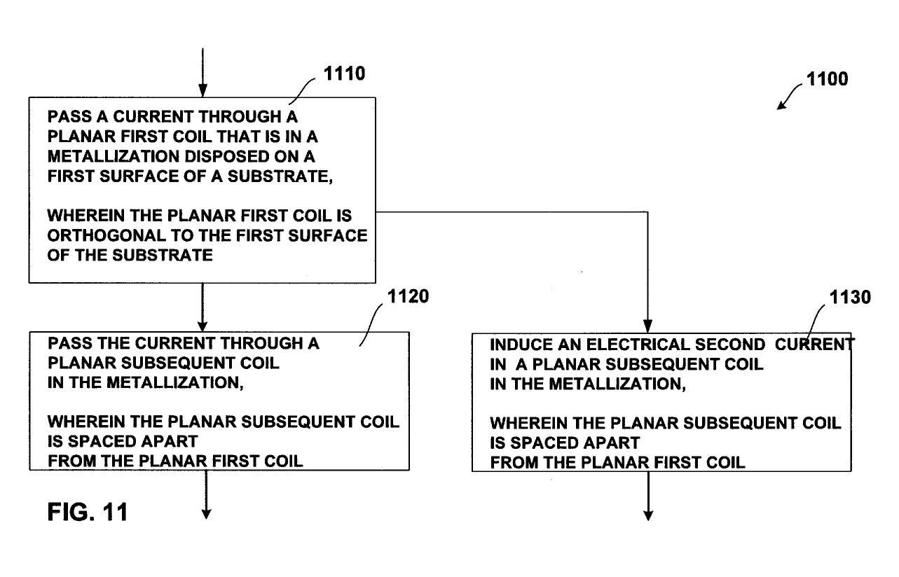

FIG. 11 is a method-flow diagram according to some embodiments.

At 1110, the method includes passing an electrical current through a planar first coil that is disposed in a metallization. The metallization is disposed on a first surface of a substrate, and the planar first coil is disposed perpendicular to the first surface.

At 1120, the method includes passing the electrical current through a planar subsequent coil in the metallization. The planar subsequent coil is parallel and spaced apart from the planar first coil.

At 1130, the method includes inducing an electrical current upon a planar subsequent coil that is in the metallization. The planar subsequent coil is parallel, spaced apart, and only inductively coupled to the planar first coil.

Embodiments disclosed herein are suitable for application in embodiments of microelectronic devices that require passive devices near the microelectronic portions. In addition, embodiments of the system discussed may be used in a wide range of wireless communication devices such as cellular phone, mobile computers, and other handheld wireless digital devices.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. In the previous discussion and in the claims, the terms “including” and “comprising” are used in an open-ended fashion, and thus should be interpreted to mean “including, but not limited to . . . ”.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. Apparatus comprising:
a substrate including a first surface;
a planar coil disposed in a metallization above the substrate, wherein the planar coil is disposed perpendicular to the first surface, and wherein the planar coil is coupled to the substrate.

2. The apparatus of claim 1, wherein the substrate is a printed wiring board.

3. The apparatus of claim 1, wherein the substrate is a semiconductive device.

4. The apparatus of claim 1, wherein the substrate is a semiconductive chip.

5. The apparatus of claim 1, wherein the planar coil has a height:width aspect ratio (AR), selected from AR≦1, AR=1, and AR≧1.

6. The apparatus of claim 1, wherein the planar coil has an AR in a range from about 0.01≦AR≦10.

7. The apparatus of claim 1, wherein the planar coil is one of a plurality of parallel spaced-apart planar coils.

8. The apparatus of claim 1, wherein the planar coil is one of a plurality of parallel spaced-apart planar coils, and wherein the planar coil has a non-contact, inductive configuration to an adjacent parallel spaced apart planar coil.

9. The apparatus of claim 1, wherein the planar coil is one of a plurality of parallel spaced-apart planar coils, wherein each planar coil has a coil width, and wherein two of the plurality of parallel spaced-apart planar coils are adjacent and spaced apart in a range from one coil width to 10 coil widths.

10. The apparatus of claim 1, wherein the metallization includes Metal-1 (M1), M2, M3, M4, M5, M6, and M7, and wherein the planar coil occupies metallization including M1, M2, M3, M4, M5, M6, and M7.

11. The apparatus of claim 1, wherein the planar coil includes a center and a perimeter, wherein the metallizations include Metal-1 (M1), M2, M3, M4, M5, M6, and M7, wherein the planar coil commences at M4 at the center, and wherein the planar coil terminates at M7 at the perimeter.

12. Apparatus, comprising:
a substrate, wherein the substrate includes a first surface and plurality of metallization layers disposed thereabove;
a planar coil coupled to the first surface, wherein the planar coil is a section of the plurality of metallization layers, and wherein the planar coil is configured perpendicular to the first surface.

13. The apparatus of claim 12, wherein the metallization layers include Metal-1 (M1), M2, M3, M4, M5, M6, and M7, and wherein the planar coil occupies metallization including M1, M2, M3, M4, M5, M6, and M7.

14. The apparatus of claim 12, wherein the planar coil includes a center and a perimeter, wherein the metallization layers include Metal-1 (M1), M2, M3, M4, M5, M6, and M7, wherein the planar coil commences at M4 at the center, and wherein the planar coil terminates at M7 at the perimeter.

15. The apparatus of claim 12, wherein the planar coil includes a center and a perimeter, wherein the metallization layers include Metal-1 (M1), M2, M3, M4, M5, M6, and M7, wherein the planar coil commences at M4 at the center, and wherein the planar coil terminates at M5 at the perimeter.

16. The apparatus of claim 12, wherein the planar coil includes a center and a perimeter, wherein the metallization layers include Metal-1 (M1), M2, M3, M4, M5, M6, and M7, wherein the planar coil commences at M4 at the center, and wherein the planar coil terminates at M6 at the perimeter.

17. The apparatus of claim 12, wherein the planar coil includes a center and a perimeter, wherein the metallization layers include Metal-1 (M1), M2, M3, M4, M5, M6, and M7, wherein the planar coil commences at M5 at the center, and wherein the planar coil terminates at M7 at the perimeter.

18. The apparatus of claim 12, wherein the planar coil includes a center and a perimeter, wherein the metallization layers include Metal-1 (M1), M2, M3, M4, M5, M6, and M7, wherein the planar coil commences at M6 at the center, and wherein the planar coil terminates at M7 at the perimeter.

19. The apparatus of claim 12, wherein the planar coil includes a center and a perimeter, wherein the metallization layers include Metal-1 (M1), M2, M3, M4, M5, M6, and M7, wherein the planar coil commences at M5 at the center, and wherein the planar coil terminates at M6 at the perimeter.

20. The apparatus of claim 12, wherein the planar coil is one of a plurality of parallel spaced-apart planar coils.

21. A process comprising:
forming a metallization above a first surface of a substrate, wherein forming a metallization includes forming a planar first coil in the metallization that is above and perpendicular to the first surface.

22. The process of claim 21, further including forming a planar subsequent coil in the metallization that is parallel planar to the planar first coil.

23. The process of claim 21, further including forming a planar subsequent coil in the metallization that is parallel planar to the planar first coil, and wherein the first coil and the subsequent coil are physically coupled at a bridge.

24. The process of claim 21, further including:
forming a planar subsequent coil in the metallization that is parallel planar to the planar first coil; and
forming a planar intermediate coil between the planar first coil and the planar subsequent coil.

25. A method comprising:
passing an electrical current through a planar first coil, wherein the planar first coil is disposed above and perpendicular to a first surface of a substrate, and wherein the planar first coil is disposed in a metallization above the first surface.

26. The method of claim 25, further including passing the electrical current through a planar subsequent coil disposed in the metallization, wherein the planar subsequent coil is parallel planar to the planar first coil.

27. The method of claim 25, further including inducing an electrical current in a planar subsequent coil disposed in the metallization, wherein the planar subsequent coil is parallel planar to and spaced apart from the planar first coil.
